(19) United States
(12) Patent Application Publication
(10) Pub. No.: US 2012/0084199 A1
(43) Pub. Date: Apr. 5, 2012

(54) AUTOMATIC FORM FILLING

(75) Inventor: Carl Stone, Campbell, CA (US)

(73) Assignee: EBAY INC., San Jose, CA (US)

(21) Appl. No.: 12/895,308

(22) Filed: Sep. 30, 2010

(51) Int. Cl. G06F 17/24; G06F 15/16; G06Q 40/00

(52) U.S. Cl. 705/39; 709/217; 715/226

(57) ABSTRACT

A user, such as a merchant, populates a form, such as an on-boarding form from a payment provider, with information unique to the user. In one embodiment, the user enters a URL address. The information is communicated to the payment provider, who then obtains additional information about the user based on the information. In one embodiment, web scraping results in a name, address, a phone number, and/or an email address for the user. The form is populated with this information by the payment provider and returned to the user for confirmation or correction. As a result, the form filling is easier for the user.

### BACKGROUND

1. Field of the Invention

The present invention generally relates to network transactions and more particularly to form filling over a network.

2. Related Art

Network transactions or Internet commerce are prevalent in today's society, partly due to the ease of use. Consumers can find, select, and pay for virtually any good or service over the Internet, such as from an on-line site, through a smart phone, PC, or other computing device. Payment can be made electronically, such as through a payment provider service like PayPal, Inc. of San Jose, Calif.

If using a payment provider, the merchant, seller, or other on-line recipient of payments, is typically asked to fill out a form from the payment provider. The form will allow the payment provider to create an account for the merchant (i.e., on-boarding), process payments for the merchant, and otherwise conduct financial transactions for the merchant. For example, a merchant account may be required before any payments can be received on-line through the payment provider.

The information required by the forms may vary, but typically would include the name of the business, address, contact information, etc. There are software tools that help pre-fill forms. However, these conventional software tools require the user to purchase and install specific form-filling software on the user's PC or computing device to accomplish these tasks. Also, when the merchant is on a different computer, the user may need to manually enter information for the on-boarding process.

Thus, even though on-line transactions are relatively easy to conduct, it is desirable to simply the process even more if possible.

### SUMMARY

According to one embodiment, a merchant or other user of a payment provider service simply enters a URL address or website of the business to automatically fill in certain required fields during an on-boarding process with the payment provider. A search is performed using the URL address to obtain information, such as name, address, contact information, and type of business. This information is then used to automatically fill in appropriate fields in a merchant on-boarding form.

In one embodiment, a form is presented to the merchant to initiate an on-boarding process. The form includes numerous fields of requested information. One such field is a URL address of the merchant site. The merchant enters the URL address, submits it to the payment provider, and the payment provider extracts information from the merchant website, such as through web scraping or another technique, to obtain the desired information. Once obtained, the payment provider automatically fills the fields of the form corresponding to the received information. The merchant can then confirm the information or correct as needed.

The form may be completely or partially filled out. If partially filled out, the merchant can enter the remaining requested information manually or by other means.

In another embodiment, in addition to the URL address, the merchant is also requested to enter a country or zip code. This allows the payment provider to determine what information will be required of this particular merchant. For example, a merchant in China may require a different on-boarding form than a merchant in the United States.

After the form has been completed, confirmed, and transmitted to the payment provider, the payment provider can create an account for the merchant. After account creation, account information is communicated to the merchant. At this point, the merchant can start receiving funds through the payment provider.

Thus, an on-boarding form can be at least partially automatically populated through a URL address or other information about the merchant or user, resulting in a simpler and easier on-boarding process.

In another embodiment, a business can enter a URL address of its business web site to more easily create a new web site, an invoicing form, or other company related content. With the URL address, information is extracted from the Internet, such as through web scraping. Information may include the name of the business, any logos, tag lines, font types, font colors, hex value colors, and anything else that may be distinctive about the business. As a result, the business can reuse its current look and feel and continue to build on it quickly and easily by just entering a URL address.

These and other features and advantages of the present disclosure will be more readily apparent from the detailed description of the embodiments set forth below taken in conjunction with the accompanying drawings.

### BRIEF DESCRIPTION OF THE FIGURES

FIG. 1 is a flowchart showing a process for automatically filling portions of a form according to one embodiment;

FIG. 2 is a flowchart showing a process performed by a user for utilizing an automatic form filling feature according to one embodiment;

FIG. 3 is a flowchart showing a process performed by a payment or identity provider for automatically filling at least portions of an on-boarding form according to one embodiment;

FIG. 4 is a block diagram of a networked system used in an on-boarding process according to an embodiment; and

FIG. 5 is a block diagram of a computer system suitable for implementing one or more embodiments.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

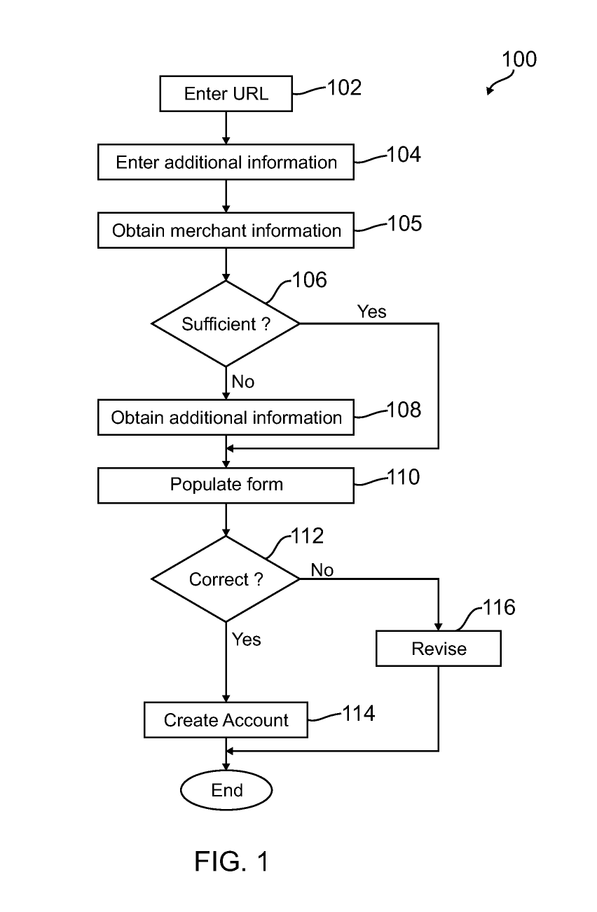

FIG. 1 shows a flowchart 100 for automatic form filling or population according to one embodiment. The process may be used by a person or entity, such as an on-line retailer or merchant, desiring to use the services of a payment provider, such as PayPal, Inc. of San Jose, Calif. Note that for purposes of the description, merchant may be used to describe anyone receiving funds through the payment provider, and need not be an actual business but can be an individual. The merchant may utilize the payment provider to process payments made to the merchant, such as for a purchase of an item or service, donation, or other money transfer. However, prior to utilizing a payment provider service, the merchant may be required to create an account with the payment provider, which may include filling out a form as part of the on-boarding process. The form is typically provided to the merchant electronically, such as through the payment provider site or the merchant site, in interactive form, but may also be provided by other means, such as a paper copy or PDF copy.

The form will include various fields for the merchant to complete. Examples of fields include, but are not limited to, name, address, phone number, account number of a merchant financial institution, tax ID number, size of business, and type of goods. In this embodiment, one of the fields is the URL (Uniform Resource Locator) address of the merchant's web site, e.g., www.companyname.com, which is the only required field. Thus, at step 102, the merchant enters the appropriate URL address.

In other embodiments, the merchant may be asked to enter additional information, such as a zip code, country, or any other information such as listed above. The additional information may be used to better process the form. For example, knowing the merchant's country can help in determining what information would be required in the form for the on-boarding process. If additional information is requested, the information may be entered at step 104.

Entry of the URL or other information may be accomplished in different ways. In one embodiment, the information is entered directly onto an electronic form from a merchant device, such as computer or phone, by using a keypad, virtual keyboard, or other data entry means. Once the requested information is entered, it is transmitted to the payment provider for processing. In one embodiment, the processing includes using the information to obtain information about the merchant required to complete or at least partially complete the on-boarding form.

At step 105, such information is obtained, such as through web scraping. Other ways may also be suitable in which information is extracted from the Internet. Web scraping can be done manually or with web scraping software to find and extract desired information. In one example, by doing a search using the merchant's URL address, the merchant's physical address, name, and phone number may be obtained, such as from a map site, business listing site, or the actual merchant web site. More private or less accessible information may be obtained as well, such as through sites in which content is available with a fee or subscription.

Once the information is obtained, a determination is made, at step 106, whether the information is sufficient to on-board the merchant. This determination may depend on the type of form and the type of information obtained. For example, the web scrape may result in the name, address, and phone number of the merchant. However, the on-boarding form may also require a federal tax ID number. In this case, the information obtained is insufficient for completing the form. Consequently, the merchant may be asked to supply any missing information, which is then received by the payment provider at step 108.

When sufficient information for completing the on-boarding form is obtained, either completely through web scraping or other means or partially through web scraping and partially through merchant entered information, the form is populated at step 108. Population can be automatically done by the payment provider with the obtained information by insertion of information into appropriate fields. After the on-boarding form is populated, the form is communicated or presented to the merchant for review.

At step 112, the merchant determines whether the form has been correctly filled out. For example, an incorrectly filled out form may result from erroneous information obtained from the web scrape or the merchant mistakenly entering wrong information. In the former situation, this can be from the merchant entering in a wrong URL address or incorrect information from the Internet source(s).

If any of the information is incorrect, the merchant may correct it at step 116. The merchant may also enter information in fields not yet populated. Once the merchant is satisfied that the information contained in the on-boarding form is correct, the payment provider processes the information and creates an account for the merchant at step 114. The new account information, such as the account number or name, may be communicated to the merchant. At this point, the merchant may begin receiving funds or having other financial transaction processed by the payment provider.

In another embodiment, the URL may be used to obtain information about the look and feel of a merchant business or site. For example, the merchant may be presented with a form to create a new website, create a form, such as an invoicing form, or some other request. The information obtained may include the business name and anything that may be distinctive about the look and feel of a merchant site, including logos, fonts, colors, etc. This information may then be used by the merchant to quickly and easily create or re-design content, either digital or physical, that has the same or similar look and feel of the merchant site.

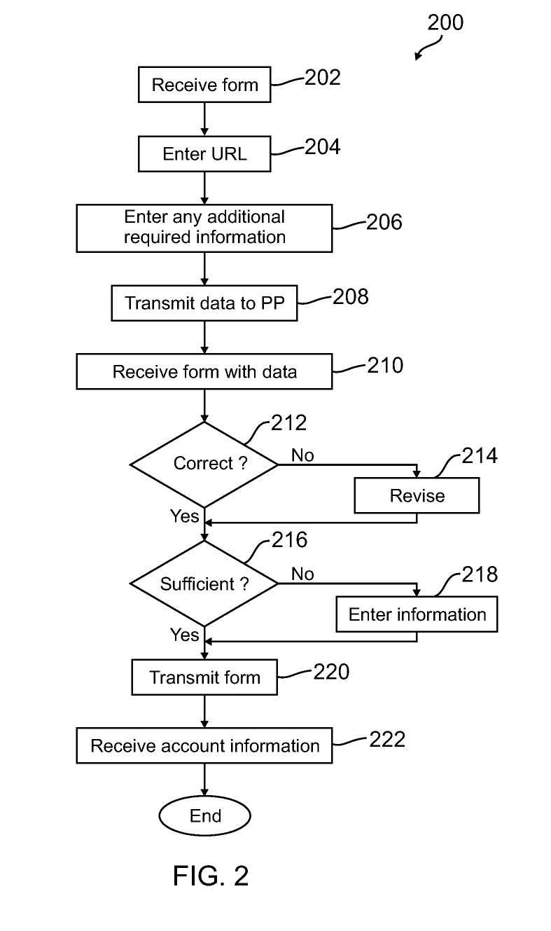

FIG. 2 shows a flowchart 200 of a process performed by a user or merchant for utilizing an automatic form filling feature according to one embodiment. At step 202, the merchant receives an on-boarding form, such as electronically through the payment provider site on a merchant device, such as a computer or PC. Next, at step 204, the merchant enters the URL address or other identifier into the form. Other identifiers may include a phone number of the merchant business or a business name. The merchant may also enter additional information, if desired or requested, at step 206. The additional information may include a zip code or country for the business, a tax ID, etc.

Once the information is entered, the merchant transmits the data to the payment provider at step 208. This can be accomplished by selecting a “send” button or other means. The payment provider then obtains information based on the received information, such as through a web scraping or other means as discussed above. When additional information is obtained, the payment provider populates the form accordingly and sends the form back to the merchant.

At step 210, the merchant receives the form with additional fields populated by the payment provider. In one example, the name, address, and phone number are filled in based on the URL address provided by the merchant. The form may be received electronically such that the merchant can edit or enter data into the form as needed.

If the information contained in the form is not correct, as determined at step 212, the merchant may revise as needed at step 214. This may include deleting or correcting certain information. The populated form received from the payment provider may indicate that one or more fields are still required to be completed. An incomplete form may be the result of the payment provider being unable to obtain the needed information based on what the merchant has provided. These required fields that need to be completed may be flagged or otherwise noted by the payment provider.

If there are such fields, as determined by the merchant at step 216, the merchant enters the requested information at step 218. Requested information may include a federal tax ID, a social security number, etc. Note that the revising at step 214 and the entering of additional information at step 218 may occur at the same time or in a different order.

Once the merchant has corrected any errors and entered any requested information, the form is transmitted back to the payment provider at step 220. Again, this can be based on a user action such as selecting a “send” button or link from the payment provider site. The payment provider then processes the information in the form, and if possible, creates an account for the merchant. Account creation may include assigning a unique account number to the merchant and anything else that is part of a typical account creation process. The merchant then receives account information at step 222, which confirms to the merchant that an account has been created, and the merchant may begin using services of the payment provider.

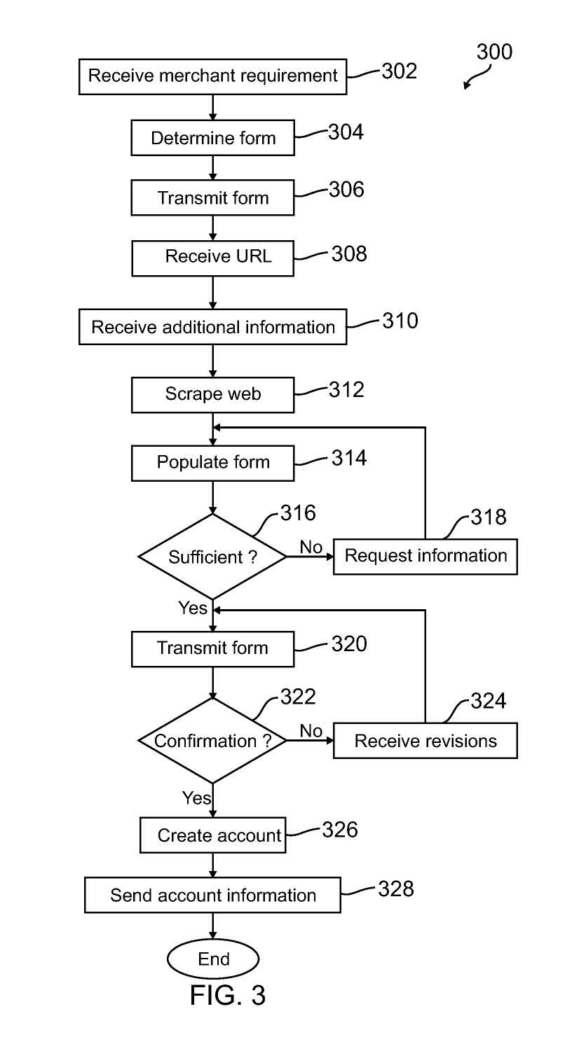

FIG. 3 is a flowchart 300 showing a process performed by a payment or identity provider for automatically filling at least portions of an on-boarding form according to one embodiment. At step 302, the payment provider receives a request from a merchant. The request may be communicated through the web site of the payment provider or the merchant and may contain a request to create an account with the payment provider. The request may be sent directly, such as the merchant initiating the request, or indirectly, such as the merchant attempting to use the payment provider service and being asked to create an account first.

Based on the request to create an account, the payment provider determines the type of form needed at step 304. Different merchants may require different forms or information to be collected. For example, forms may differ based on country, type of goods, size of the merchant, etc. The payment provider may also determine which fields of the form are required by the merchant to complete. Traditionally, the merchant may be required to fill in a large number of fields, making the process time-consuming. In one embodiment, the payment provider only requires a URL address of the merchant or some other identifier, such as business phone number or address.

Once the type of form and required fields are determined, the form is transmitted to the merchant at step 306. Transmission is typically electronically, allowing the merchant to enter the desired information directly into the form. The merchant then enters the requested information (e.g., the URL address) and transmits the form back to the payment provider. The URL address is received by the payment provider at step 308. If the merchant enter any other information, either voluntary or requested by the payment provider, this additional information is also received, at step 310, where the URL and the additional information may be received in the same transmission.

After receiving the information, the payment provider uses the information to scrape the web, at step 312, or other information harvesting, to obtain additional information about the merchant. The web scraping may be with done with standard software programs or can be customized as needed to obtain and filter the desired information. In one example, the scraping obtains a business name, a business address, and a business phone number at a minimum. Other information may include type and size of the business and email address.

Next, at step 314, the payment provider populates the form with the information obtained through the merchant and the web scraping. For example, the name, address, phone number, and email address fields may be completed by the payment provider from web scraping data and the web site address may be completed from the merchant provided information. After populating with the available information, a determination is made at step 316 whether that information is sufficient to on-board the merchant. If there is insufficient data, the payment provider requests the missing information from the merchant at step 318. This may entail highlighting fields in the form where the merchant is to complete or correct.

Once the payment provider determines that the necessary fields of the form are completed, the form is transmitted to the merchant at step 320, and the payment provider waits to see if a confirmation is received, at step 322. A confirmation is sent by the merchant if the received form has no errors and the merchant does not want to add or change any information. A confirmation may be sent by the merchant selecting a “confirmation” link or button or other similar means to indicate the contents of the form are accurate.

If no confirmation is received, the payment provider may instead receive revisions from the payment provider at step 324. The revisions may be reviewed and/or accepted, and the revised form sent back to the merchant for approval or confirmation. Once the merchant has approved the information in the on-boarding form, the payment provider processes the information to create an account for the merchant at step 326. After account creation, account information is sent to the merchant, along with a confirmation if desired, at step 328. For example, the merchant may receive an account number and a temporary password, a link to access the account, or any other relevant information.

Thus, using some minimal merchant identifiers, like a URL address, the payment provider can automatically populate fields in an on-boarding form or other form from information obtained using the identifier. This results in less work and data entry for the merchant to create an account with the payment provider.

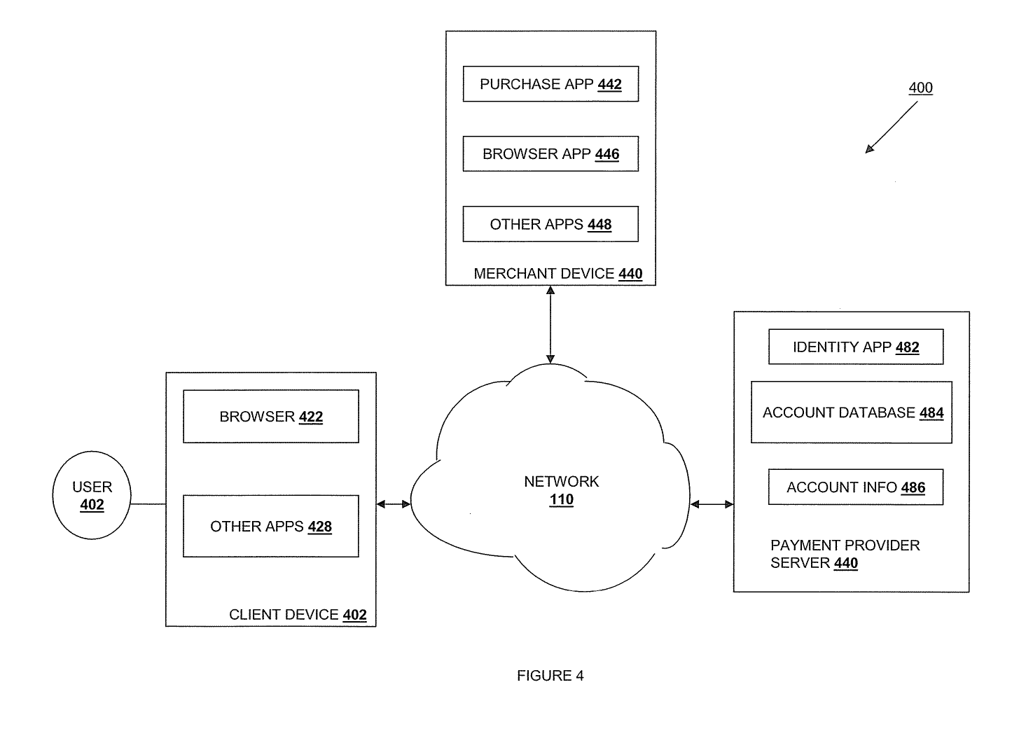

FIG. 4 is a block diagram of a networked system 400 used in used in an on-boarding process, such as described above, according to an embodiment of the invention. System 400 includes a client device 410, a merchant device 440, and a payment service provider server 470 in communication over a network 460. Payment service provider server 470 may be maintained by a payment provider, such as PayPal, Inc. of San Jose, Calif.

Network 460, in one embodiment, may be implemented as a single network or a combination of multiple networks. For example, in various embodiments, network 460 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client device 410, in one embodiment, may be implemented using any appropriate combination of hardware and/or software configured for wired and/or wireless communication over network 460. For example, client device 410 may be implemented as a personal computer of a user 402 (e.g., a client or customer) in communication with network 460. In other examples, client device 410 may be implemented as a wireless telephone (e.g., cell phone), personal digital assistant (PDA), notebook computer, and/or various other generally known types of wired and/or wireless computing devices. It should be appreciated that, in various embodiments, client device 410 may be referred to as a user device or a customer/client device without departing from the scope of the present disclosure.

Client device 410, in one embodiment, may include one or more browser applications 422 which may be used to provide a user interface to permit user 402 to browse information available over network 460. For example, browser application 422 may be implemented as a web browser to view information available over network 460. In one implementation, browser application 422 comprises a software program, such as a graphical user interface (GUI), executable by a processor that is configured to interface and communicate with the one or more merchant devices 440 and payment provider server 470 via network 460. For example, user 402 is able to access merchant websites to view and select items or services for purchase, as well as list items or services for sale by the user. User 402, through client device 410, may also communicate with payment provider server 470 to create an account as described herein.

As such, client device 410, in one embodiment, may include other applications 428 as may be desired in one or more embodiments to provide additional features available to user 402, including conducting an on-boarding or form-filling process with payment provider server 470. For example, applications 428 may include interfaces and communication protocols that allow the user to receive and transmit information via an interactive form or display. Applications 428 may also include security applications for implementing client-side security features, programmatic client applications for interfacing with appropriate application programming interfaces (APIs) over network 460 or various other types of generally known programs and/or applications.

Merchant device 440, which can be similar to client device 410, may be maintained by one or more service providers (e.g., merchant sites, auction site, marketplaces, social networking sites, etc.) offering various items, such as products and/or services. Merchant device 440 may be in communication with a merchant server capable of handling various on-line transactions. The merchant (which could be any representative or employee of the merchant) can create an account with the payment provider in order to receive payments from purchasers through the payment provider. Merchant device 440 may include purchase application 442 for offering products/services for purchase.

Merchant device 440, in one embodiment, may include a browser application 446 and other applications 448, similar to browser application 422 and applications 428 in client device 410. Browser application 446 and applications 448 enable the merchant to access a payment provider web site and communicate with payment provider server 470, such as to convey and receive information to fill out an on-boarding form from the payment provider. As described in greater detail herein, embodiments of the present disclosure provide a way for the merchant to quickly fill in or complete a payment provider form by communicating with payment provider server 470.

Payment provider server 470, in one embodiment, may be maintained by an online payment provider, which may provide processing for online financial and information transactions on behalf of user 402 with a merchant. Payment provider server 470 may include at least one identity application 482, which may be adapted to interact with the client device 410 and/or merchant device 440 over network 460 to facilitate the purchase of items, products and/or services by user 402.

Payment provider server 470, in one embodiment, may be configured to maintain a plurality of user and merchant accounts in an account database 484, each of which may include or be separate from an account information 486 associated with individual users, including the user 402, and one or more merchants or sellers associated with one or more merchant devices 440. For example, account information 486 may include identity information of user 402 and merchants, such as one or more full names, business names, street addresses, email addresses and phone numbers, or other types of financial information, which may be used to facilitate online transactions between user 402 and merchants. As such, identity application 482 may be configured to interact with a merchant server, user, or other payee to process, obtain, and store information for form filling and other tasks. Identity application 482 may also populate and store completed forms for users of the payment provider service.

In one implementation, user 402 and/or a merchant has identity attributes stored with payment provider server 470, and user 402 and/or the merchant has credentials to authenticate or verify identity with payment provider server 470. Identity attributes may include personal information (e.g., user name, password, photograph image, biometric id, residence address, business address, social security number, tax ID, phone number, email address, etc.) and banking information (e.g., banking institution, credit card issuer, account numbers, security information, etc.). These attributes may be obtained from the user and/or merchant directly or through web scraping or other means. In various implementations, one or more identity attributes may be passed to payment provider server 470 as part of a form-fill request, and the attributes may be used by payment server 470 to obtain additional information for the form through various sources, such as during a web scraping.

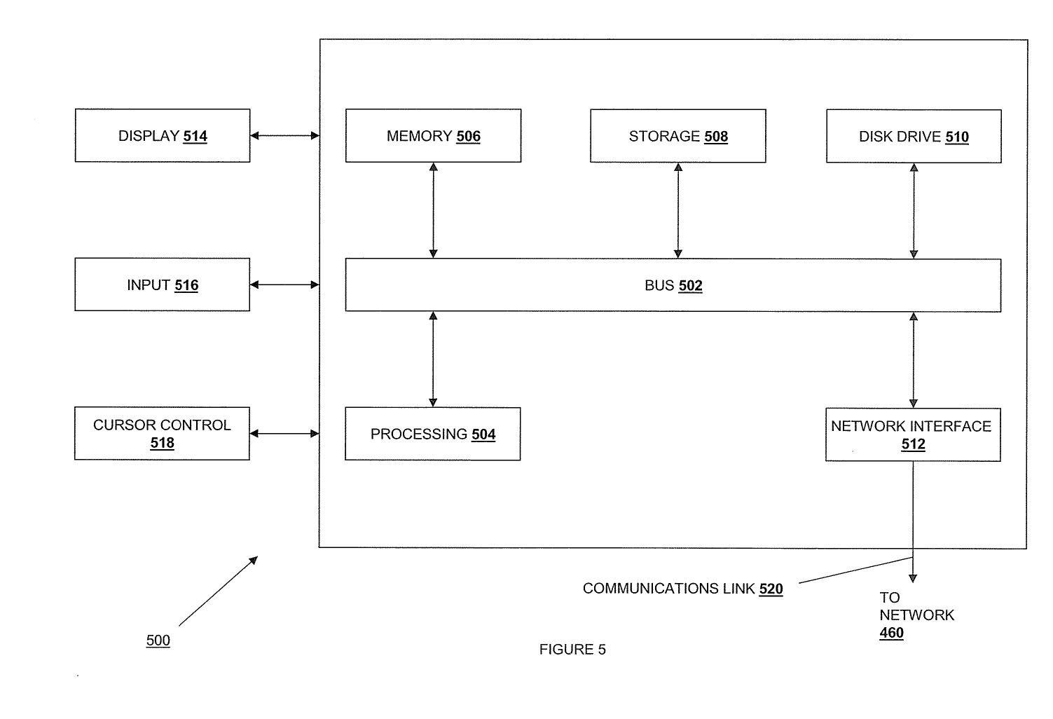

FIG. 5 is a block diagram of a computer system 500 suitable for implementing one or more embodiments of the present disclosure. In various implementations, the user and/or merchant device may comprise a personal computing device (e.g., a personal computer, laptop, smart phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

In accordance with various embodiments of the present disclosure, computer system 500, such as a personal computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 516 (e.g., keyboard, keypad, or virtual keyboard), and a cursor control component 518 (e.g., mouse, pointer, or trackball). In one implementation, disk drive component 510 may comprise a database having one or more disk drive components.

In accordance with embodiments of the present disclosure, computer system 500 performs specific operations by processor 504 executing one or more sequences of instructions contained in system memory component 506, such as described above with respect to the consumer, merchant, and/or payment provider in FIGS. 1-3. Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by a communication link 520 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and a communication interface 512. Network interface component 512 may include an antenna, either separate or integrated, to enable transmission and reception via communication link 520. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above description is directed to a payment provider. However, other entities, such as identity providers or services that can obtain information from the Internet, may also be suitable for automatically populating one or more fields of an on-boarding form. Furthermore, a merchant identifier, other than the URL address of the merchant site, may be used to obtain the additional information for the on-boarding form, so long as the identifier is sufficient to locate desired information from a search. In addition, form filling has been discussed with respect to on-boarding a merchant; however, the invention may be utilized for any sort of automatic form filling. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for facilitating information transactions over a network, the system comprising:
a first component adapted to communicate with a user via a first device over the network; and
a second component adapted to receive a form partially populated by the user with a first information via the first device over the network and provide the first device with a form populated with the first information and a second information obtained from the first information.

2. The system of claim 1, wherein the user is a merchant.

3. The system of claim 1, wherein the first information is a URL address of the user and wherein the user is a merchant.

4. The system of claim 1, wherein the second information comprises a name, address, and phone number.

5. The system of claim 4, wherein the second information further comprises an email address.

6. The system of claim 1, wherein the first information is a unique identifier for the user.

7. The system of claim 1, wherein the second information is obtained through a web scraping.

8. The system of claim 1, wherein the form is an on-boarding form so that the user can receive money through a payment provider.

9. The system of claim 8, wherein the system is managed by the payment provider.

10. The system of claim 1, wherein the second component is further adapted to determine whether the first and second information are sufficient to fill in required fields of the form.

11. The system of claim 1, wherein a payment provider provides the form to the user device via the network.

12. The system of claim 11, wherein the form includes one or more fields of required information for the user to enter.

13. The system of claim 1, further comprising a third component adapted to store account information of the user when an account is created for the user based on at least the first and second information in the form.

14. A method for facilitating information transactions over a network, the method comprising:
communicating with a user via a client device over the network;
receiving a form partially populated with first information from the user;
obtaining, by a processor of an on-line service provider, second information of the user based on the first information; and
populating additional fields of the form with the second information.

15. The method of claim 14, further comprising transmitting the form to the user over the network, wherein the form includes fields indicating required information from the user.

16. The method of claim 14, further comprising determining, by the processor, whether the first and the second information are sufficient to complete the form.

17. The method of claim 16, further comprising requesting additional information from the user if the processor determines the first and second information are insufficient to complete the form.

18. The method of claim 14, further comprising creating an account for the user based on information in the form.

19. The method of claim 14, wherein the on-line service provider is a payment provider.

20. The method of claim 14, wherein the first information comprises a unique identifier of the user.

21. The method of claim 20, wherein the unique identifier is a URL address.

22. The method of claim 14, wherein the second information comprises a name, an address, and a phone number of the user.

23. A machine-readable medium comprising a plurality of machine-readable instructions which when executed by one or more processors of a server are adapted to cause the server to perform a method comprising:
communicating with a user via a client device over the network;
receiving a form partially populated with first information from the user;
obtaining second information of the user based on the first information; and
populating additional fields of the form with the second information.
